(19) United States
(12) Patent Application Publication
(10) Pub. No.: US 2008/0246871 A1
(43) Pub. Date: Oct. 9, 2008

(54) IMAGE DISPLAY UNIT WITH SENSOR DEVICE MOUNTED TO FRAME

(75) Inventors: Walter KUPPER, Woerth (DE); Uwe NAGEL, Karlsruhe (DE); Laurence PAGET, Erlangen (DE)

Correspondence Address: SUGHRUE MION, PLLC, 2100 PENNSYLVANIA AVENUE, N.W., SUITE 800, WASHINGTON, DC, 20037, US

(73) Assignee: EIZO GmbH, Karlsruhe (DE)

(21) Appl. No.: 12/098,277

(22) Filed: Apr. 4, 2008

Related U.S. Application Data
(63) Continuation of application No. PCT/EP2006/067092, filed on Oct. 5, 2006.

(30) Foreign Application Priority Data
Oct. 6, 2005 (DE) DE 102005048023.3

(51) Int. Cl. H04N 5/222

(52) U.S. Cl. 348/333.01; 348/E05.022

(57) ABSTRACT

An image display unit (1) with a front frame (2) and with a sensor device (6) provided with a sensor (9). The sensor (9) is provided for detecting the luminance and/or the color location of an image that displayed on a display (7) of the image display unit (1). To detect luminance, known image display units have a sensor support that, in a non-operating position, is placed in a recess of a frame of a flat screen in an area that cannot be seen by a viewer. Suitable drives make it possible for the sensor support to swivel out from its non-operating position into a position for detecting the luminance. The production of an image display unit of this type is complex. In addition, the drives are susceptible to malfunction, making continuous and fault-free luminance detection impossible. The disclosed arrangement avoids these drawbacks.

This is a Continuation of International Application PCT/EP2006/067092, with an international filing date of October, which was published under PCT Article 21(2) in German, and the complete disclosure of which, including amendments, is incorporated into this application by reference.

### FIELD AND BACKGROUND OF THE INVENTION

The invention relates to an image display unit with a front frame and with a sensor device provided with a sensor. The sensor is provided to detect the luminance and/or the color location of an image that can be displayed on a display of the image display unit.

Such an image display unit is disclosed in WO 2005/036511. To detect the luminance, this device has a sensor support, which in a non-operating position is arranged in a recess of the frame of a flat screen that is not visible to a viewer. Through suitable drive means, the sensor support can be swiveled out of this non-operating position to a luminance detection position.

The manufacture of such an image display unit is costly. Furthermore, the drive means are susceptible to malfunction, so that continuous and fault-free luminance detection is not possible. Moreover, the sensor device must be calibrated at specified time intervals at an appropriate laboratory, which requires the sensor support to be removed with special tools.

### OBJECT OF THE INVENTION

One object of the present invention is to provide an image display unit of the above-described type that obviates these disadvantages.

### SUMMARY OF THE INVENTION

This and other objects are achieved by providing the sensor device and the front frame with structure to mount the sensor device to the front frame, such that the structure allows the sensor device to be mounted at a plurality of positions on a side of the front frame, so that the luminance can be detected.

One advantage is that the user is free to choose where to mount the sensor device on the front frame. A user will preferably mount the sensor device where it does not disturb his work on the image display unit. It may be necessary, for example, to move the sensor device from the top left of the front frame to the bottom left because based on a graphic user interface displayed on the image display unit, information is displayed only in the upper area of the display of the image display unit. Easy mounting and removal of the sensor device simplifies recalibration of the sensor device, which is typically done at specified time intervals in a factory setting or in a suitable laboratory, for example.

In addition, image display units that are not equipped with a luminance detection device can be retrofitted with such a sensor device by simply mounting the fixation structure to the front frame and the sensor device.

Specific embodiments of the invention provide that the fixation structure is made of a magnetic material or takes the form of a Velcro strip fastener or a snap-on connection, e.g. to ensure simple mounting and removal of the sensor device.

Other advantageous embodiments of the invention are described below and recited in various dependant claims.

### BRIEF DESCRIPTION OF THE DRAWINGS

The invention, its embodiments and advantages will now be explained in greater detail with reference to an exemplary embodiment of the invention that is depicted in the drawing, in which:

FIG. 1 shows an image display unit with a sensor device, and

FIG. 2 is a section taken along line II-II in FIG. 1.

### DETAILED DESCRIPTION OF THE PREFERRED EMBODIMENTS

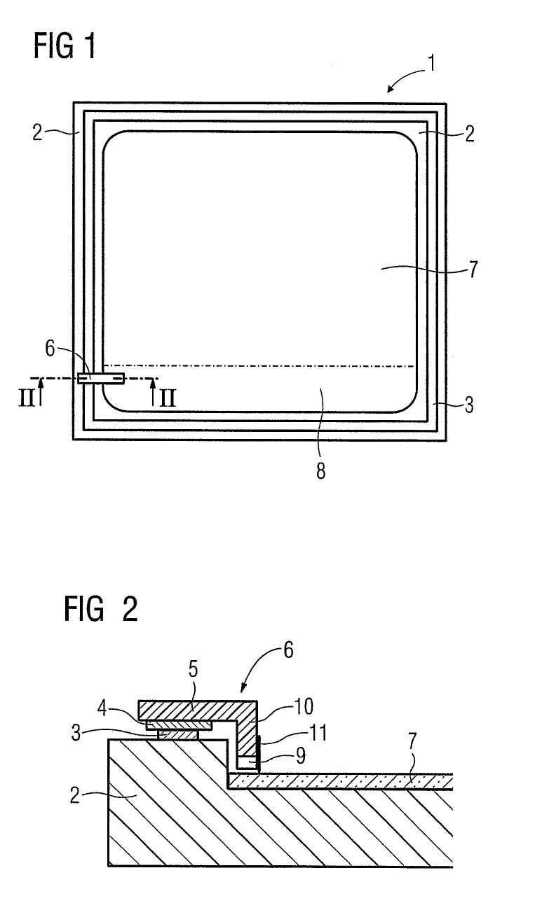

In FIG. 1, 1 identifies an image display unit with a fixation strip 3 made of a magnetic material arranged on the front frame 2. The magnetic strip 3 is, for example, glued to the front frame 2 or fixed to the front frame 2 in some other manner. The magnetic strip 3 of the front frame 2 is in operative engagement with a magnetic strip 4 of a mounting arm 5 of a sensor device 6, such that the sensor device 6 can be arranged and fixed at any point of the front frame 2. A user will preferably fix the sensor device wherever it does not disturb him during work on the image display unit 1. It may occur, for example, that on a display 7 of the image display unit 1, an application executed by a personal computer connected to the image display unit 1 causes information to be displayed only in the upper area of the display 7, while a lower, narrow area 8 of the display 7 remains unused. In this case, arranging the sensor device 6 on the front frame 2 such that the luminance is detected by a sensor 9 of the sensor device 6 in the narrow area 8 would not cause any interference for a user or viewer. For another application, it may be necessary to position the sensor device 6 at a different location on the front frame 2, so that the information displayed on the display 7 is not covered up. To prevent ambient light from interfering with luminance detection, a holder 10 of the sensor device 6 that is provided with the sensor 9 and is disposed at a substantially right angle to the mounting arm 5, has a sealing lip 11 to shield the sensor 9 from ambient light. The sensor device 6 is connected to a measurement evaluation unit of the image display unit 1, a personal computer or some other control computer via a wire-bound or wireless communication interface (not depicted) so that the detected luminances can be processed, for example, with respect to a brightness, contrast or luminance setting or some other setting of the image display unit.

The above description of the preferred embodiments has been given by way of example. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

What is claimed is:

1. An image display unit comprising:
a display, a front frame, and a sensor device with a sensor detecting at least one of a luminance and a color location of an image displayed on the display,
wherein the sensor device and the front frame comprise means for mounting the sensor device to the front frame, and wherein the means mount the sensor device in any one of a plurality of positions on a side of the front frame for detecting a luminance of the image.

2. An image display unit as claimed in claim 1, wherein the mounting means comprise a magnetic material.

3. An image display unit as claimed in claim 1, wherein the mounting means comprise at least one of a Velcro strip fastener and snap-on connections.

4. An image display unit as claimed in claim 1, wherein the sensor device comprises a mounting arm mounting the sensor device to the front frame and a holder arranged at a substantially right angle to the mounting arm, receiving and holding the sensor, such that the holder extends toward the display.

5. An image display unit as claimed in claim 4, wherein the holder comprises a seal shielding the sensor from ambient light.

6. An image display unit comprising:
a display, a front frame, and a sensor device with a sensor detecting at least one of a luminance and a color location of an image displayed on the display,
wherein at least one of the sensor device and the front frame comprises a mounting element mounting the sensor device to the front frame in any one of a plurality of positions on a side of the front frame for detecting a luminance of the image.
